(19) United States
(12) Patent Application Publication
(10) Pub. No.: US 2026/0288083 A1
(43) Pub. Date: Sep. 24, 2026

(54) DETECTION DEVICE AND TIMEPIECE

(71) Applicant: CASIO COMPUTER CO., LTD., Tokyo (JP)

(72) Inventor: Tomoyasu KUROKAWA, Tokyo (JP)

(21) Appl. No.: 19/571,940

(22) Filed: Mar. 19, 2026

(30) Foreign Application Priority Data
Mar. 21, 2025 (JP) 2025-047411

(51) Int. Cl. G04G 21/02; G04G 17/04

(52) U.S. Cl. CPC G04G 21/025; G04G 17/04

(57) ABSTRACT

A detection device includes: a light emitter emitting light toward a first direction; a light receiver; a back cover with a first opening and a second opening respectively corresponding to the light emitter and the light receiver; a window provided on a first direction side of the back cover and having integrated metal base and light transmitter, the base having a third opening and a fourth opening respectively corresponding to the light emitter and the light receiver, and the light transmitter closing the third opening and the fourth opening; and a light shield between the window and the back cover. The light shield corresponds to at least part of a region corresponding to outer circumference of the light emitter and entire circumference of a region corresponding to outer circumference of the light receiver, and the window is bonded to the back cover by adhesive over entire outer circumference.

### CROSS-REFERENCE TO RELATED APPLICATION

This application claims priority and benefit of Japanese Patent Application No. 2025-047411, filed on Mar. 21, 2025. The entire disclosure of Japanese Patent Application No. 2025-047411, filed on Mar. 21, 2025, including description, claims, drawings and abstract is incorporated herein by reference.

### BACKGROUND OF THE INVENTION

### Technical Field

The present disclosure relates to a detection device and a timepiece.

### Description of Related Art

JP2018007887A discloses a timepiece (“electronic device” in JP2018007887A) in which an opening is formed in a metal back cover with a light emitter and a light receiver inside, a transparent glass is provided to block the opening, and a detection device for detecting biometric information such as pulse is provided inside the back cover.

### SUMMARY OF THE INVENTION

According to an aspect of the present disclosure, there is provided a detection device comprising:
a light emitter that emits light toward a first direction;
a light receiver;
a back cover with a first opening corresponding to the light emitter and a second opening corresponding to the light receiver;
a window which is provided on a first direction side of the back cover and in which a metal base and a light transmitter are integrated with each other, the metal base being formed with a third opening corresponding to the light emitter and a fourth opening corresponding to the light receiver, and the light transmitter closing each of the third opening and the fourth opening; and
a light shield that is provided between the window and the back cover, wherein
the light shield is provided to correspond to at least part of a region corresponding to an outer circumference of the light emitter and an entire circumference of a region corresponding to an outer circumference of the light receiver, and
the window is bonded to the back cover by an adhesive over an entire outer circumference.

### BRIEF DESCRIPTION OF THE DRAWINGS

FIG. 1 is a front view of a timepiece for an embodiment.

FIG. 2 is a plan view of a back cover unit for the embodiment, viewed from the back of the timepiece.

FIG. 3 is a diagram of the key parts of the back cover unit shown in FIG. 2.

FIG. 4 shows a key sectional view along the IV-IV line of the back cover unit in FIG. 2.

### DETAILED DESCRIPTION

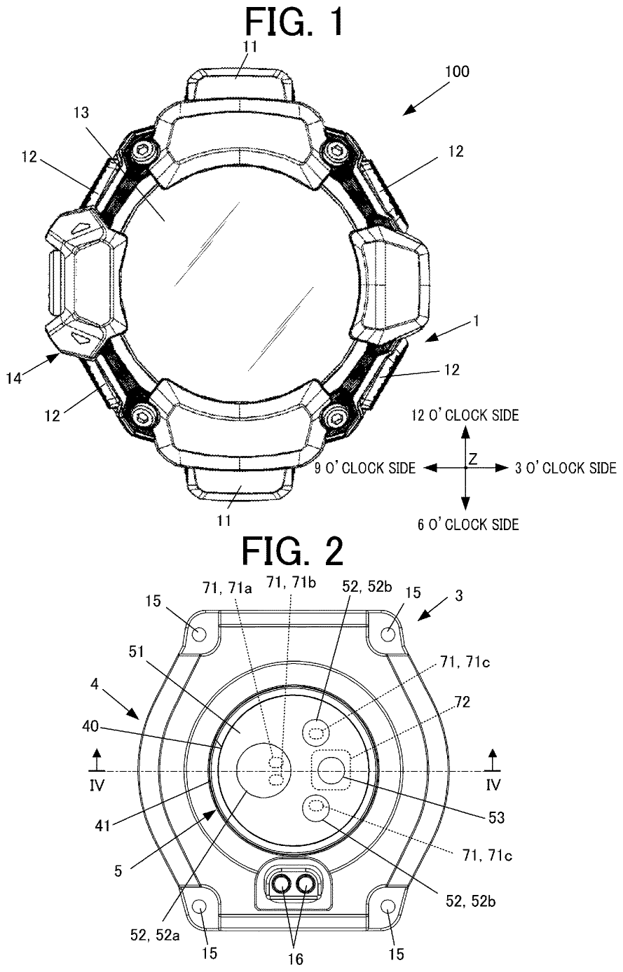

With reference to the drawings, one embodiment of a detection device in accordance with the present disclosure and a timepiece equipped with the detection device will be described. The embodiment will be illustrated with the example of a case in which the timepiece is a wristwatch (hereinafter simply referred to as “timepiece 100”) to be worn on the user's arm. In the following description, each direction in the timepiece 100 shown in FIG. 1 follows that of an analog timepiece display. The Z direction is the thickness direction (up and down) of the timepiece 100. The front side, which is the visible side of the timepiece 100, is referred to as the “upper side (up), front side” and the back side as the “lower side (down), back side” in the Z direction. The “first direction” in the following description is the lower side of the Z direction. The embodiments described below are subject to various limitations that are technically desirable for implementing the disclosure, but the scope of the disclosure is not limited to the following embodiments and illustrative examples.

In the embodiment, the timepiece 100 has a device case 1. The device case 1 is formed of a relatively hard synthetic resin, such as an engineering plastic or super engineering plastic. The materials used to form the device case 1 are not limited to those illustrated here. The device case 1 may be formed of a metallic material such as stainless steel (SUS), for example. The device case 1 is cylindrical along the Z direction, the direction of thickness of the timepiece 100, and is a hollow short column shape with openings at the top and bottom in the Z direction. The hollow portion inside the device case 1 constitutes a storage space for various components. Although not shown in the figure, the hollow portion of the device case 1 houses various components such as modules. The specific configuration of the module is not described in detail, but when the timepiece 100 is an electronic timepiece, the module includes the various operating parts of the timepiece 100, the controller that controls these parts, the battery, and other components. The timepiece 100 may be equipped with an analog-type display with hands, and the like, not shown, or a digital-type display with, for example, a liquid crystal display.

As shown in FIG. 1, at the 12 o'clock and 6 o'clock positions on the analog timepiece in the outer part of the device case 1, there are a pair of band attachment sections 11 to which a band, not shown, is attached. The device case 1 is equipped with, on its outer parts or the like, various operation sections 12 (pushbuttons, crowns, and the like) for various input operations by the user. The placement, number, shape, and the like of the operation sections 12 are not limited to the illustrated example. Furthermore, the opening portion on the front side of the device case 1 (the visible side in the timepiece, the upper side in the Z direction) is closed by the windshield member 13. The windshield member 13 is a transparent member (cover member) formed, for example, of glass material or transparent resin material. It is preferable that the windshield member 13 is attached via a waterproof ring or the like. By interposing a waterproof ring or the like between the windshield member 13 and the device case 1, the opening portion is closed in an airtight condition. Also, on the front side of the device case 1 (the visible side in the timepiece), there is an exterior member 14 (bezel) that surrounds the opening portion. It is not essential to have an exterior member 14.

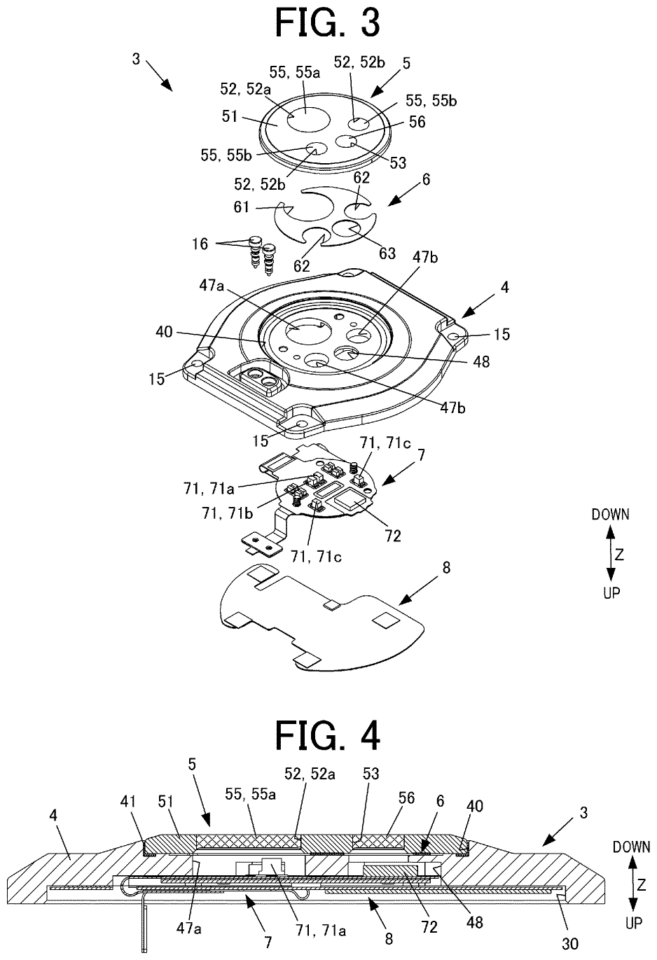

The back cover unit 3 (see FIGS. 2 and 3) is attached to the opening portion of the back side of the device case 1 (non-visible side in the timepiece). The back cover unit 3 has screw holes 15 as shown in FIG. 2, for example, and is screwed to the device case 1 by inserting screws (not shown) through the screw holes 15. It is preferable that the back cover unit 3 is attached to the device case 1 via a waterproof ring or the like, not shown. By attaching the back cover unit 3 via a waterproof ring, or the like, the opening portion of the back side of the device case 1 (non-visible side in the timepiece) can be closed while ensuring water resistance (airtightness) in the device case 1. A terminal section 16 for charging is provided on the back cover unit 3 side of the device case 1 (see FIG. 2). The back cover unit 3 is a detection device in the embodiment and includes a back cover 4, a window 5, and a light shield 6. In the embodiment, the detection device detects biometric information, such as pulse and oxygen saturation, for example.

In the embodiment, the back cover 4 is formed of a relatively hard synthetic resin, such as an engineering plastic or super engineering plastic. The materials used to form the device case 1 are not limited to those illustrated here. It may be formed of resin materials other than those illustrated here. The back cover 4 has therein a light emitter (light emitting section 71) that emits light toward the first direction and a light receiver (light receiving section 72). Specifically, on the upper side of the back cover 4 in the Z direction, there is a recess 30 that constitutes a housing space. As shown in FIGS. 3 and 4, a flexible printed circuits (FPC) board 7 and a diaphragm 8, and the like are placed in the recess 30. The diaphragm 8 is a metal plate to which a piezoelectric body such as a piezoelectric element (not shown) is attached, for example. When voltage is applied, vibration is generated by the difference in elasticity between the piezoelectric body and the metal plate. The vibration is then repeated to output a beep (vibration sound). The diaphragm 8 is placed on top of the FPC board 7 (on the upper side in the Z direction). The provision of the diaphragm 8 is not an essential configuration. If there is no need to output a beep sound, it can be configured without the diaphragm 8.

On the lower side in the Z direction on the FPC board 7, components necessary for detecting biometric information, such as light emitting sections 71 and a light receiving section 72, are mounted. The light emitting section 71 comprises a light emitter that projects light, such as an LED (Light Emitting Diode), for example. In the embodiment, the light emitters (light emitting sections 71) include at least a first light emitter emitting light of red wavelengths and a second light emitter emitting light of green wavelengths, as described below. The LED in the light emitting section 71 emits light (projects light) toward the first direction (downward in the Z direction). When the timepiece 100 is worn on the user's arm, the lower side of the back cover unit 3 in the Z direction contacts the user's wrist or other skin. The light projected from the light emitting section 71 hits and reflects off the user's skin. The light receiving section 72 comprises a light receiver that detects light and outputs an electrical signal corresponding to the amount of light received. In the embodiment, the light receiving section 72 receives light projected from the light emitting section 71 and reflected by the user's skin. For example, photodiodes or illuminance sensors can be used as the light receiver.

In the embodiment, the light emitting section 71 includes a light emitting section 71a that includes an LED projecting infrared light, a light emitting section 71b that includes an LED projecting light of red wavelengths (R), and light emitting sections 71c that include an LED projecting light of green wavelengths (G). Of these, infrared (IR) light is light in the range above and beyond the “wavelength range 380 to 750 nm,” which is the human visible light range, and unlike visible light, is invisible to the human eye. The light emitting section 71a is used, for example, to detect the attachment and removal of the timepiece 100. In addition, infrared (IR) light is easily absorbed by reduced hemoclobin (Hb). In contrast, light of red wavelengths (R) is easily absorbed by hemoclobin oxide (HbO2). For example, light of green wavelengths (G) with a peak wavelength of 520 nm to 530 nm is easily absorbed by hemochrobin in blood. Part of the light irradiated on the user's skin is absorbed by the blood in the blood vessels. Therefore, the amount of reflected light from the skin received by the light receiving section 72 changes over time in response to changes in blood flow associated with the pulsation of the heart. The pulse is detected based on this change in the amount of light received, and the pulse rate can be measured based on the detected pulse. When two types of light, one of red wavelengths (R) and the other of non-red wavelengths (R) (for example, light of green wavelengths (G)), are applied to the skin, the hemoglobin bound to oxygen and the hemoglobin unbound to oxygen have different amounts of the two types of light transmitted. Therefore, oxygen saturation can be measured by detecting the difference in transmission amount between the two types of light. The placement, and the like of the light emitting sections 71 and light receiving section 72 are not limited to the example shown in FIGS. 2 and 3.

In the embodiment, the back cover 4 has openings 47, 48 (through holes that pass through the front and back of the back cover 4) on the lower surface of the recess 30 (the lower surface in the Z direction, the first direction), corresponding to the light emitting sections 71 and the light receiving section 72, respectively. That is, an opening 47a is formed corresponding to the light emitting sections 71a, 71b, and openings 47b are formed corresponding to light emitting sections 71c. The openings 47a, 47b corresponding to the light emitting sections 71a, 71b and 71c are “first openings”. An opening 48 is formed corresponding to the light receiving section 72. The opening 48 corresponding to the light receiving section 72 is the “second opening”. As shown in FIG. 4, each light emitting section 71 is exposed to the lower side of the back cover 4 (lower side in the Z direction) through openings 47a, 47b, and the light receiving section 72, at least part of the light receiving surface, is exposed to the lower side of the back cover 4 (lower side in the Z direction) through the opening 48 (second opening).

The window 5 is placed on the first direction side (lower side in the Z direction) of the back cover 4. Specifically, a recess 40 (see FIG. 4) is formed on the first direction side (lower side in the Z direction) of the back cover 4 of the embodiment, and the window 5 is provided within the recess 40. The window 5 is bonded to the back cover 4 by an adhesive 41 around its entire outer circumference. In the embodiment, the adhesive 41 is a thermosetting resin. This allows, for example, the window 5 to be placed in the recess 40 after pouring the adhesive 41 into the inner circumference of the recess 40 of the back cover 4, and then fixing the window 5 to the back cover 4 by applying heat. Alternatively, the window 5 can be placed in the recess 40, then the adhesive 41 can be poured between the inner circumference of the recess 40 and the window 5, and heat can be applied to cure the adhesive 41. By bonding and fixing the back cover 4 and window 5 by heat curing using the adhesive 41, the water resistance is fully guaranteed. The adhesive 41 is not limited to this and may be other than thermosetting resin.

The window 5 is a member in which a metal base 51 and light transmitters 55, 56 are integrated with each other, the base 51 having openings 52 (third openings) corresponding to the light emitting sections 71 (light emitters) and an opening 53 (fourth opening) corresponding to the light receiving section 72 (light receiver), and the light transmitters 55, 56 closing the respective openings 52, 53. The opening 52 (third opening) includes an opening 52a, which corresponds to the light emitting sections 71a, 71b, and openings 52b, which correspond to light emitting sections 71c. The light transmitter 55 is a transparent member formed of, for example, transparent glass material, and includes a light transmitter 55a, which closes the opening 52a, and light transmitters 55b, which close the openings 52b. The light transmitter 56 closes the opening 53 (fourth opening).

The method of integrating the metal base 51 with the light transmitters 55, 56 is, for example, glass hermetic sealing. Glass hermetic seals can be matched (matched sealing) or compression-type seals (compression sealing), both of which provide excellent airtightness. The method of forming the window 5 of the embodiment may be by any of the following. For example, in a compression-type (compression sealing) glass hermetic seal, a metal such as stainless steel (SUS) is used as the base 51, and the two are sealed using compressive stress caused by the expansion difference between the base 51 (metal) and the light transmitters 55, 56 (glass). According to this method, the base 51 and light transmitters 55, 56 can be integrated without any packing or various sealing materials, and the like, and no raising is generated around the light transmitters 55, 56, thus the surfaces on the first direction side (lower side in the Z direction) of the base 51 and light transmitters 55, 56 of the window 5 can be made substantially flush with each other.

In the embodiment, at least part of the openings 52 (third openings) corresponding to the light emitting sections 71 (light emitters) has a larger opening area (here, “area” indicates the size of region) than the opening 53 (fourth opening) corresponding to the light receiving section 72 (light receiver). In the illustrated example, the opening 52a, which corresponds to the light emitting sections 71a, 71b, has a larger opening area than the other openings. The embodiment uses the opening 52a, which has a larger opening area than the others, as an inspection window to inspect the water resistance of the timepiece 100. Inspection of the water resistance of a timepiece is usually done by looking to see if any fogging appears on the surface of the glass member after the timepiece is submerged in water. If the water resistance is not sufficient, water will enter the device case 1, causing fogging on the surface of the glass members. In general, the windshield member 13 in the opening portion of the device case 1 on the upper side in the Z direction is used as the glass member to view the fogged condition. However, it may be difficult to check the fogging condition with the windshield member 13, for example, when a sheet-type display device is provided on the inner surface of the windshield member 13. In this regard, the embodiment enables inspection for water resistance using the light transmitter 55 in the opening 52a, which is formed with a relatively large diameter (opening area). In particular, in the embodiment, the light transmitter 55 is integrated with the base 51 by means of a glass hermetic seal technique. Therefore, the light transmitter 55 does not have a raised outer circumference due to packing or sealing material, and the like, and this ensures for a wider glass surface that can be used as a window for inspection.

The light shield 6 is provided between the window 5 and the back cover 4. The light shield 6 has an adhesive surface on at least one of the sides in contact with the window 5 or the back cover 4. The light shield 6 in the embodiment shall be a light-shielding black or other double-sided tape with an adhesive surface on both the side in contact with the window 5 and the side in contact with the back cover 4. The light shield 6 is not limited to those shown here. The light shield 6 is provided around the entire circumference of the region corresponding to the outer circumference of the light receiving section 72 (light receiver). The light shield 6 corresponds to at least part of the region corresponding to the outer circumference of the light emitting sections 71 (light emitters). In other words, as shown in FIG. 3, the light shield 6 of the embodiment has an unbroken opening 63 around the light receiving section 72 (light receiver), which surrounds the entire 48 of the back cover 4. However, the openings 61, 62 corresponding to the openings 47, which are around the light emitting sections 71 (light emitters), are partially notched in some areas that become the inner circumference when placed in the recess 40 (corresponding to the outer circumference of the window 5). Thus, the light shield 6 is provided between the light emitting sections 71 (light emitters) and between the light emitting sections 71 (light emitters) and the light receiving section 72 (light receiver), as well as with a gap around the outer circumference. However, as mentioned above, the outer circumference of the window 5 is bonded all around by the adhesive 41. Therefore, when the window 5 can be bonded and fixed to the recess 40 of the back cover 4, all around each light emitting section 71 (light emitter) and light receiving section 72 (light receiver) are ensured in a light-shielded state.

Next, the action of the back cover unit 3 as a detection device in embodiment and the timepiece 100 equipped with this unit will be described. When assembling the timepiece 100 of this embodiment, first place the FPC board 7 on which the light emitting section 71 (light emitter) and the light receiving section 72 (light receiver) are mounted in the recess 30 on the upper side of the back cover 4 in the Z direction. On the FPC board 7, the light emitting section 71 (light emitter) is set to emit light toward the first direction (downward in the Z direction), and the light receiving section 72 (light receiver) is set in an orientation that can receive reflected light projected from the light emitting section 71 (light emitter) and reflected on the user's skin. When placing the FPC board 7 in the recess 30, the position is aligned so that the light emitting section 71 (light emitter) corresponds to the opening 47 and the light receiving section 72 corresponds to the opening 48. The diaphragm 8 is then placed above the FPC board 7 (on the upper side in the Z direction).

The light shield 6 is placed in the recess 40 formed on the lower side of the back cover 4 in the Z direction. The light shield 6 in the embodiment is a double-sided tape, which is affixed in the recess 30 by aligning the position and orientation to shield the entire circumference of light receiving section 72 (light receiver) and between the light emitting sections 71 (light emitters) and between the light emitting sections 71 (light emitters) and the light receiving section 72 (light receiver). That is, the opening 63 is placed in the position corresponding to the opening 48, the opening 61 is placed in the position corresponding to the opening 47a, and the opening 62 is placed in the position corresponding to the opening 47b. The window 5 with the metal base 51 and the light transmitters 55, 56 integrated with each other is placed in the recess 30, aligning the position of each of the openings 52, 53 (light transmitters 55, 56 corresponding to the openings 52, 53) with the position and orientation of the openings 47, 48 of the back cover 4. Since the light shield 6 is double-sided tape in the embodiment, placing the window 5 over the light shield 6 in the recess 30 temporarily fixes the window 5. Then, the adhesive is poured between the inner circumference of the recess 30 and the window 5, and heat is applied to adhere the adhesive. This completes the back cover unit 3 shown in FIGS. 2 and 4.

Then, the module is housed in the case 1, and the opening portion on the upper side in the Z direction (visible side) is closed with the windshield member 13, and the opening portion on the lower side in the Z direction (non-visible side) is closed with the back cover unit 3. This completes the timepiece 100 with the back cover unit as the detection device.

The timepiece 100 in the embodiment is intended to be worn on the user's arm. In the worn state, the surface of the back cover unit 3 in the first direction (lower side in the Z direction) is in contact with the user's skin. When measuring the pulse rate, as described above, infrared (IR) light which has the property of being easily absorbed by reduced hemoclobin (Hb) is projected from the light emitting section 71a toward the first direction (downward in the Z direction), and the infrared light (IR) reflected on the skin surface is received by the light receiving section 72. The light emitting section 71b, which projects light of red wavelengths (R) having a property of being easily absorbed by hemoclobin oxide (HbO2), also projects light toward the first direction (downward in the Z direction), and the light of red wavelengths (R) reflected on the skin surface is received by the light receiving section 72. Since part of the light irradiated on the user's skin is absorbed by the blood in the blood vessels and changes in accordance with the change in blood flow rate associated with the pulsation of the heart, the pulse can be detected from the change in the amount of light received by the light receiving section 72 of the light reflected from the skin. The pulse rate is then measured based on the detected pulse.

When measuring oxygen saturation, light of red wavelengths (R) is emitted from the light emitting section 71b, which projects light toward the first direction (downward in the Z direction), and light of red wavelengths (R) reflected on the skin surface is received by the light receiving section 72. Light of green wavelengths (G), which is light other than red wavelengths (R), is also projected from the light emitting section 71c toward the first direction (downward in the Z direction), and light of green wavelengths (G) reflected on the skin surface is received by the light receiving section 72. Light of the green wavelengths (G) is easily absorbed by hemoclobin in blood. Thus, when two types of light are applied to the skin, there is a difference in the transmission amount of the two types of light between hemoglobin bound to oxygen and hemoglobin unbound to oxygen. Therefore, oxygen saturation can be measured by detecting the difference transmission amount of the two types of light. The measurement of oxygen saturation is not limited to the method described above. For example, instead of projecting light of green wavelengths (G) from the light emitting section 71c, infrared (IR) light may be projected from the light emitting section 71a, and the infrared light (IR) reflected on the skin surface may be received by the light receiving section 72, so that oxygen saturation is measured by detecting the difference in the transmission amount between the infrared light (IR) and the light of red wavelengths (R) projected from the light emitting section 71b.

Infrared (IR) light, which is invisible to the human eye, is projected from the light emitting section 71a toward the first direction (downward in the Z direction), and the IR light reflected on the skin surface is received by the light receiving section 72, allowing to detect the attachment and removal of the timepiece 100 without making the user aware of being measured. In other words, if infrared (IR) light is projected from the light emitting section 71a and the reflected light is received by the light receiving section 72, it can be judged that the timepiece 100 is worn on the arm. If infrared (IR) light is projected from the light emitting section 71a but the reflected light is not received by the light receiving section 72, it can be judged that the timepiece 100 is not worn on the arm.

The back cover unit 3, which is a detection device in the embodiment, uses a window 5 in which the base 51 and the light transmitters 55, 56 are integrated by means of a glass hermetic seal technique and the first direction side surfaces are substantially flush with each other. Therefore, there is almost no unevenness on the side that touches the user's arm when the device is worn, and the device feels good against the skin and has good wearability, even though it is configured to enable detection of various types of biometric information. The less unevenness also shortens the distance between the light emitting section 71 and the skin, and the distance between the light receiving section 72 and the skin. Furthermore, the light shield 6 ensures light shielding between the light emitting section 71 and the light receiving section 72, so that there is little risk of the light receiving section 72 picking up light other than reflected light from the skin. This allows for more accurate measurements. The shorter distance from the light emitting section 71 to the skin allows accurate measurement results to be obtained even if the output of light emitters such as LEDs in the light emitting section 71 is suppressed, and also reduces power consumption when performing various detection operations. Furthermore, by integrating the base 51 and the light transmitters 55, 56, the number of parts can be reduced compared to the case in which packing or other members are interposed, and the device can be made thinner because there is no need to ensure a thickness or the like for securing packing or the like.

In addition, when inspecting for water resistance, the timepiece 100 is submerged in water to see if fogging appears on the surface of the light transmitter 55 in the opening 52a, which is formed with a relatively large diameter (opening area). If the water resistance is sufficient, water does not enter the device case 1 and fogging does not appear. If the water resistance is not sufficient, water enters the device case 1, causing fogging on the surface of the light transmitter 55, which is a glass member. In the embodiment, the light transmitters 55, 56 are integrated with the base 51 without any packing or sealing material, so there is no unnecessary raising, and the like on the outer circumference of the light transmitter 55, and a wide glass surface that can be used as a window for inspection can be ensured.

As described above, the detection device for the embodiment is a back cover unit 3 provided on the timepiece 100, and includes: light emitting sections 71 (light emitters) that emit light toward the first direction (downward in the Z direction); a light receiving section 72 (light receiver); a back cover 4 that has openings 47a, 47b (first openings) corresponding to the light emitting sections 71 and an opening 48 (second opening) corresponding to the light receiving section 72; a window 5 which is provided on a first direction side of the back cover 4 and in which a metal base 51 and light transmitters 55, 56 are integrated with each other, the metal base 51 being formed with openings 52 (third openings) corresponding to the light emitting sections 71 and an opening 53 (fourth opening) corresponding to the light receiving section 72, and the light transmitters 55, 56 closing the respective openings 52, 53; and a light shield 6 that is provided between the window 5 and the back cover 4. The light shield 6 is provided so as to correspond to at least part of the region corresponding to the outer circumference of the light emitting section 71 and the entire circumference of the region corresponding to the outer circumference of the light receiving section 72. The window 5 is bonded to the back cover 4 over the entire circumference of the outer circumference by an adhesive 41.

In the configuration described in the background art, an opening is formed in the metal back cover with the light emitter and light receiver inside, and the underside of the glass that closes the opening protrudes beyond the underside of the back cover. This creates a large gap between the arm and the detection device when measuring biometric data, causing light leakage and making accurate measurement difficult. In addition, since there is only one opening corresponding to the light emitter and light receiver, and they are not shielded from each other, it is difficult to accurately measure the biometric data. The configuration of the present disclosure reduces the unevenness of the surface of the back cover unit 3 in the first direction (lower side in the Z direction) compared to the conventional technology, and the distance between the light emitting section 71 and the skin and the distance between the light receiving section 72 and the skin are reduced. This reduces the loss of light emitted toward the skin that attenuates before reaching the skin, thereby increasing the amount of light irradiated per unit area of skin. Therefore, accurate measurement results can be obtained even if the output of the light emitting section 71 is suppressed, and power consumption can also be reduced. The close distance between the light emitting section 71 and the skin also reduces the risk of the light receiving section 72 picking up light other than reflected light from the skin. The opening is divided between each light emitting section 71 and light receiving section 72, and each opening is shielded by light shield 6 to prevent light leakage. This improves the accuracy of the measurement. In this sense, the system also eliminates the need for more output than necessary from the light emitting section 71, contributing to lower power consumption.

In the embodiment, the surfaces on the first direction side (lower side in the Z direction) of the base 51 and the light transmitters 55, 56 of the window 5 are substantially flush with each other. By integrating the light transmitters 55, 56 with the base 51 without using packing or sealing material as in the case of embodiment, a less uneven surface can be formed, which improves wearability by making the device comfortable against the skin when worn. In addition, the distance from the light emitting section 71 and light receiving section 72 to the skin is closer, and the less unevenness improves the adhesion between the back cover unit 3 and the skin and suppresses light leakage, thereby improving the accuracy of the measurement results. Furthermore, the distance between the light emitting section 71 and the skin is closer, which means that the light output is low enough to make measurements, which also reduces power consumption. Furthermore, the back cover unit 3, which functions as a detection device, can be made thinner, and its design can be improved.

A recess 40 is formed in the first direction side (lower side in the Z direction) of the back cover 4 of the embodiment, and the window 5 is provided in the recess 40. Therefore, the window 5 does not protrude to the first direction side (lower side in the Z direction). Therefore, the distance between the first direction side (lower side in the Z direction) of the window 5 in contact with the skin and the light emitting section 71 and the light receiving section 72 becomes closer, and thus, the distance between the light emitting section 71 and the light receiving section 72 and the skin can be brought closer, which improves the accuracy of measurement results and also reduces the light output of the light emitting section 71.

The back cover 4 of the embodiment is formed of resin material. This allows the overall weight of the timepiece 100 to be reduced compared to forming the back cover 4 with metal. When swinging the arm in a marathon or running, and the like, if the weight of the entire timepiece 100 is heavy, the swinging motion of the arm may cause the timepiece 100 to swing significantly, resulting in unsteady state, which may reduce the accuracy of the measurement. In this respect, in the embodiment, the back cover unit 3, which is the detection device, can be configured by fitting the window 5, which consists of the integrated metal base 51 and light transmitters 55, 56, which are glass, into the resin back cover 4, enabling reduction in weight compared to the case where the entire back cover 4 is made of metal. Therefore, even when swinging the arms during running or marathon running, and the like, the measurement is highly resistant to noise caused by arm swinging, and the like, and measurement accuracy is improved, resulting in more accurate measurement results. In addition, power consumption can be reduced because accurate measurements can be made even when the output of the light emitting section 71 is suppressed.

The adhesive 41 of the embodiment is a thermosetting resin. Therefore, the back cover 4 and window 5 can be bonded and fixed together simply by applying heat with the adhesive 41 interposed in the gap between the inner surface of the recess 40 of the back cover 4 and the window 5, thereby ensuring water resistance.

The light emitter, which is the light emitting section 71 in the embodiment, is composed of LEDs. This allows them to emit light with relatively low power consumption.

The light shield 6 has an adhesive surface on at least one of the sides in contact with the window 5 or the back cover 4. This prevents the orientation and position of the light shield 6 from shifting during the assembly process, facilitating placement and positioning. In the embodiment, the light shield 6 is double-sided tape, which allows for smooth placement of the light shield 6 against the back cover 4, as well as temporary fixing of the window 5 to the back cover 4.

The light emitter, which is the light emitting section 71 in the embodiment, includes at least a light emitting section 71b as a first light emitter that projects (emits) light of red wavelengths (R) and a light emitting section 71c as a second light emitter that projects (emits) light of green wavelengths (G). Light of red wavelengths (R) is easily absorbed by hemoclobin oxide (HbO2), and some of the light irradiated on the user's skin is absorbed by the blood in the blood vessels. Therefore, the pulse can be detected based on changes in the amount of light received by the light receiving section 72 of reflected light from the skin, and the pulse rate can be measured based on the detected pulse. Oxygen saturation can also be measured by exposing the skin to two types of light: light of red wavelengths (R) and light of non-red wavelengths (R), such as light of green wavelengths (G), for example, and detecting the difference in transmission amount of the two types of light.

In the embodiment, at least part of the opening 52 (first opening) corresponding to the light emitter, which is the light emitting section 71 (opening 52a in the embodiment), has a larger opening area than the opening 53 (second opening) corresponding to the light receiver, which is the light receiving section 72. This allows the waterproofing of the timepiece 100 to be inspected using the light transmitter 55a in the opening 52a. In the embodiment, the opening 52a is formed with a larger opening area and the light transmitter 55a in the opening 52a is used to inspect the waterproofing of the timepiece 100, but the opening 52 with a larger opening area is not limited to the opening 52a. The opening 52b may be formed with a larger opening area, and a light transmitter 55b in the opening 52b may be used to inspect the waterproofing of the timepiece 100.

Since the timepiece 100 in the embodiment is equipped with a back cover unit 3 that functions as a detection device in this way, various types of biometric information, such as pulse and oxygen saturation, can be acquired simply by wearing the timepiece 100.

Although the embodiments of the present disclosure have been described above, it goes without saying that the present disclosure is not limited to such embodiments and can be varied in various ways to the extent that it does not depart from the gist thereof. For example, in this embodiment, the case in which one light receiving section 72 is provided for light emitting sections 71a, 71b, 71c is illustrated, but there may be multiple light receiving sections 72. It can be configured to have multiple sets of light emitting and light receiving sections by providing a light receiving section 72 for each of the light emitting sections 71a, 71b, and 71c. There does not have to be multiple light emitting sections 71, for example, only the light emitting section 71b as the first light emitter that projects (emits) light of red wavelengths (R). In this case, the pulse can still be detected by looking at the change in the amount of light received by the light receiving section 72. Oxygen saturation can also be detected if equipped with a light emitting section 71b that projects (emits) light of red wavelengths (R) and a light emitting section 71 that projects (emits) light of red wavelengths (R). For this purpose, two light emitting sections 71 that are the light emitting section 71b, which projects (emits) light of red wavelengths (R), and light emitting section 71c, which projects (emits) light of green wavelengths (G), may be provided, or two light emitting sections 71, that are the light emitting section 71b which projects (emits) light of red wavelengths (R), and light emitting section 71a, which projects (emits) infrared (IR) light.

In this embodiment, the case in which the light emitter (light emitting section 71) and the light receiver (light receiving section 72) provided in the back cover unit 3, which is a detection device, are provided inside the back cover 4 (in the recess 30 of the back cover 4) is illustrated. However, it is not essential that the light emitting section 71 and the light receiving section 72 be provided inside the back cover 4. It is sufficient that the light emitting section 71 is provided in a position corresponding to the openings 47a, 47b (first opening) formed on the back cover 4 and thus, the opening 52 (third opening) formed on the window. It is sufficient that the light receiving section 72 is located at a position corresponding to the opening 48 (second opening) which is formed in the back cover 4, and thus the position corresponding to the opening 53 (fourth opening). The light emitting section 71 and light receiving section 72 may be located outside of the back cover 4, as long as the location corresponds to each opening.

In this embodiment, the case in which back cover 4, which constitutes back cover unit 3, is formed of resin is shown as an example, but the material used to form back cover 4 is not limited to resin. The back cover 4 may be made of a metallic material such as titanium or stainless steel (SUS), for example.

In this embodiment, the case in which the back cover unit 3 functioning as a detection device is applied to a wristwatch-type timepiece 100 is illustrated, but the device to which the detection device is applied is not limited to a timepiece. For example, it can be widely applied to electronic devices such as various types of smartwatches, sports watches, and other wearable devices that acquire biometric information such as heartbeat and blood flow information as well as time.

Although several embodiments of the present disclosure have been described above, the scope of the present disclosure is not limited to the embodiments described above, but includes the scope of the invention described in the claims and its equivalents.

What is claimed is:

1. A detection device comprising:
a light emitter that emits light toward a first direction;
a light receiver;
a back cover with a first opening corresponding to the light emitter and a second opening corresponding to the light receiver;
a window which is provided on a first direction side of the back cover and in which a metal base and a light transmitter are integrated with each other, the metal base being formed with a third opening corresponding to the light emitter and a fourth opening corresponding to the light receiver, and the light transmitter closing each of the third opening and the fourth opening; and
a light shield that is provided between the window and the back cover, wherein
the light shield is provided to correspond to at least part of a region corresponding to an outer circumference of the light emitter and an entire circumference of a region corresponding to an outer circumference of the light receiver, and
the window is bonded to the back cover by an adhesive over an entire outer circumference.

2. The detection device according to claim 1, wherein
surfaces on the first direction side of the base and the light transmitter in the window are substantially flush with each other.

3. The detection device according to claim 1, wherein a recess is formed on the first direction side of the back cover, and the window is provided in the recess.

4. The detection device according to claim 1, wherein the back cover is formed of a resin material.

5. The detection device according to claim 1, wherein the adhesive is a thermosetting resin.

6. The detection device according to claim 1, wherein the light emitter includes an LED.

7. The detection device according to claim 1, wherein the light shield has an adhesive surface on at least one of a side in contact with the window or a side in contact with the back cover.

8. The detection device according to claim 1, wherein the light emitter includes at least a first light emitter that emits light of a red wavelength and a second light emitter that emits light of a green wavelength.

9. The detection device according to claim 1, wherein at least part of the first opening corresponding to the light emitter has a larger opening area than the second opening corresponding to the light receiver.

10. A timepiece comprising:
a light emitter that emits light toward a first direction;
a light receiver;
a back cover with a first opening corresponding to the light emitter and a second opening corresponding to the light receiver;
a window which is provided on a first direction side of the back cover and in which a metal base and a light transmitter are integrated with each other, the metal base being formed with a third opening corresponding to the light emitter and a fourth opening corresponding to the light receiver, and the light transmitter closing each of the third opening and the fourth opening; and
a light shield that is provided between the window and the back cover, wherein
the light shield is provided to correspond to at least part of a region corresponding to an outer circumference of the light emitter and an entire circumference of a region corresponding to an outer circumference of the light receiver, and
the window is bonded to the back cover by an adhesive over an entire outer circumference.

11. The timepiece according to claim 10, wherein surfaces on the first direction side of the base and the light transmitter in the window are substantially flush with each other.

12. The timepiece according to claim 10, wherein a recess is formed on the first direction side of the back cover, and the window is provided in the recess.

13. The timepiece according to claim 10, wherein the back cover is formed of a resin material.

14. The timepiece according to claim 10, wherein the adhesive is a thermosetting resin.

15. The timepiece according to claim 10, wherein the light emitter includes an LED.

16. The timepiece according to claim 10, wherein the light shield has an adhesive surface on at least one of a side in contact with the window or a side in contact with the back cover.

17. The timepiece according to claim 10, wherein the light emitter includes at least a first light emitter that emits light of a red wavelength and a second light emitter that emits light of a green wavelength.

18. The timepiece according to claim 10, wherein at least part of the first opening corresponding to the light emitter has a larger opening area than the second opening corresponding to the light receiver.
